(19) United States
(12) Patent Application Publication
(10) Pub. No.: US 2002/0018880 A1
(43) Pub. Date: Feb. 14, 2002

(54) Stamping foils for use in making printed circuits and radio frequency antennas

(76) Inventor: Robert P. Young, Willow Grove, PA (US)

Correspondence Address: W. Edward Johansen, 11661 San Vicente Boulevard, Los Angeles, CA, 90049, US

(21) Appl. No.: 09/824,477

(22) Filed: Apr. 2, 2001

Related U.S. Application Data
(60) Provisional application No. 60/222,291, filed on Aug. 1, 2000.

(51) Int. Cl. B32B 15/00; B32B 7/00

(52) U.S. Cl. 428/209; 428/458; 428/901

(57) ABSTRACT

A stamping foil includes a carrier film, a layer of heat activated adhesive, a layer of vacuum deposited copper, a substrate and a release layer. The layers are activated by heat and pressure by a die which causes the layers to delaminate from the carrier film and adhere to a surface of a substrate in a predetermined electrically conductive pattern. The release layer releasably couples the layer of vacuum deposited copper to the substrate.

This is a continuation-in-part of a provisional application filed Aug. 1, 2000 under Ser. No. 60/222,291.

### BACKGROUND OF THE INVENTION

This invention also relates to stamping foils for use in making printed circuits and radio frequency antennas.

U.S. Pat. No. 4,987,424 teaches an antenna apparatus in which flexible antennas are made of a conductive material and are formed on a flexible insulating sheet. An insulating film made of a synthetic resin material is used as the insulating sheet and the antennas are formed by adhering a metal foil on the insulating sheet or by depositing a metal film on the insulating sheet. The antenna apparatus is for outdoor use and is widely used. The antenna apparatus is also used indoors. Since shapes and sizes of the antenna apparatus are limited to obtain necessary characteristics, it is difficult to realize a good design. The antenna apparatus has three-dimensional shapes and hence occupy large spaces as a whole.

U.S. Pat. No. 4,495,232 teaches a stamping foil which forms printed circuit patterns on a non-conductive substrate. The substrate includes an electrically conductive layer made of a highly conductive metal, such as copper, which is endowed with a sufficiently low shear strength, even in thicknesses of 10 microns or more, to permit easy and sharp separation of the activated (imprinted) and non-activated portions of the foil. The low shear strength may be achieved with fibrous or fibrous-granular crystallite structure. The fibers are oriented approximately at right angles to the surfaces of the foil, and, in addition, by doping agents containing carbon, nitrogen and sulfur. The foil includes a bonding layer for bonding the electrically conductive layer to the non-conductive substrate. The bonding layer may be applied to the surface of the electrically conductive layer before the stamping operation. The electrically conductive layer may adhere to a carrier tape through an intermediary separating layer. In the latter case, the bonding and separating layers become activated when compressed by a stamping die or stereotype. The electrically conductive layer becomes bonded to the non-conductive substrate and separated from the carrier tape in the activated areas. The activated and non-activated portions of the foil are then separable by pulling the carrier tape away from the non-conductive substrate.

Electrical and electronic circuits are made often of printed wiring or foil on insulating boards. The usual manufacturing processes expend materials and labor and require complicated equipment. On substrates which are coated either with copper (subtractive technique or metalizing technique) or with a bonding agent containing a sensitizer (additive or semi-additive technique) the conductive patterns are brought out by screen printing or photoprinting, and the printed circuit boards are etched, depending on the process used, after an initial strike of copper by chemical displacement or plating followed by electro-deposition of copper or tin. Between these main procedural steps are other necessary steps, such as cleaning, removal of the mask, drying and checking. All other parts of switching or measuring instruments, such as housings, mechanically movable parts, mechanical supports or connections, can be produced by methods which are capable of a high output per unit time (e.g., pressure diecasting, stamping, drawing, etc.), the production of printed circuit boards by wet chemical means consumes a disproportionately high amount of time and work.

U.S. Pat. No. 4,012,552 teaches a surface which is decorated with a metal film in a pattern. The metal film is made by applying an area of thin frangible metal to a temporary carrier, printing an adhesive in the pattern desired for the metal on either the metal film or receiving surface, the area of the pattern being less than the area of the metal film, pressing and adhering the receiving surface and metal film together with the adhesive therebetween and stripping away the carrier. The metal over the adhesive remains on the receiving surface to provide the decorative metal pattern and the balance is carried away with the carrier. The receiving surface can be a final surface to be decorated or can be the exposed surface of an ink design heat transfer. In the latter case, a combined heat transfer having both a decorative metal film pattern and a multicolor ink design can be provided by coating the receiving surface, after transfer of the metal film pattern thereto, with a second adhesive over both the metal pattern and ink design.

U.S. Pat. No. 3,463,651 teaches a method which includes the steps of printing an ink design on the release surface of a plastic film, metallizing by vacuum deposition the entire release surface and over-coating with an adhesive. It is not possible to provide metal in a pattern on the decal. The paper cannot be used as a backing. A transfer die is required. The carrier web must be removed from the press for metallizing and remounted for coating the adhesive.

U.S. Pat. No. 5,821,859 teaches a magnetic tag which serves both as an identifier of the article to which it is attached and as an anti-theft device. The former attribute is especially important should stolen property be recovered. Identification comes about through the use of an array of individual magnetic elements that are closely spaced, preferably along and perpendicular to an amorphous wire or strip. The magnetic elements can take the form of magnetic ink, high conductivity wire, thin foil, or amorphous wire. The array may be personalized (coded) by leaving out elements of the array or driving selected elements to saturation while others remain demagnetized. The elements can also be in the form of a double array to constitute '1's and '0's to form a code. Reading of the elements is accomplished with a special reading head consisting or one or more small magnetic circuits coupled to one or more pickup loops. A longer length of soft magnetic wire or thin strip is used to trigger an anti-theft alarm when activated by an external field from a magnetic gate.

U.S. Pat. No. 5,977,931 teaches a low visibility, field-diverse antenna. The antenna provides cross-polarized fields enhancing signal communications. A generally flat, but helical, antenna is achieved in conjunction with a core substrate about which the antenna is wrapped, wound, or fixed. The core substrate, pitch or angle of the helix, and length of the transmitting antenna are chosen for a specific resonant frequency. The length and width of the helix are chosen in order to dimension the helical antenna between its linear and circular polarization modes to thereby deliver field-diverse and cross-polarized transmission modes. In order to optimize the manufacturing process, holes may be created within the substrate. These holes are plated with conducting material so that conducting foil on opposite faces of the substrate may be electrically connected. The holes may be offset according to the pitch of the helix. Once the transmitting antenna has been fabricated upon the core substrate the margin, which is between the plated-through holes and the edge of the substrate, may be separated by cutting, sawing or stamping. The small, low-power antennas can achieve better signal transmission and power efficiencies while avoiding intentional, mischievous destruction.

U.S. Pat. No. 6,177,871 teaches a method for producing paperboard packaging (trays, lids, cartons, containers or combinations) with an integral RF-EAS security tag and a procedure for tuning the resonance frequency of the tag.

U.S. Pat. No. 5,781,110 teaches a method for forming such tags on one side of a substrate by utilizing a combination laminating printing procedure. These devices have been found to be inadequate in use because they do not resonate sharply enough to be detected by conventional and widely distributed detectors. No means is provided for controlling the resonance frequency of such tags. There remains a need in the art to provide a reliable and tunable security tag at reduced costs. The RF-EAS tag can be applied directly to the package component during the manufacturing process, eliminating the need for separate application and can be precisely tuned for controlling the resonance frequency.

The inventor hereby incorporates all of the above-referenced patents into this specification.

### SUMMARY OF INVENTION

The present invention is generally directed to a stamping foil for use in producing electrically conductive circuits on a non-conductive substrate.

In a first, separate aspect of the present invention, the stamping foil includes a carrier film, a layer of heat activated adhesive, a release layer and a layer of vacuum deposited copper. Gold, silver and platinum may also be used. The layers are activated by heat and pressure by a die which causes the layers to delaminate from the carrier film and adhere to a surface of the non-conductive substrate in a predetermined electrically conductive pattern.

In a second, separate aspect of the present invention, the stamping foil is bondable to the substrate in areas and which is activated by compression with a stamping die or stereotype. The stamping foil includes an electrically conductive layer which has a thickness of between 50 Angstroms to 1000 Angstroms to achieve the required electrical functions. The stamping foil is endowed with sufficiently low shear strength to permit sharp separation of the activated areas from unactivated areas of the stamping foil following a stamping operation.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### BRIEF DESCRIPTION OF THE DRAWINGS

FIG. 1 is a schematic cross-sectional diagram of a stamping foil according to U.S. Pat. No. 4,495,232 prior to the stamping operation.

FIG. 2 is a schematic cross-sectional diagram of the stamping foil of FIG. 1 immediately after stamping and separation of the activated (compressed) and unactivated portions of the foil.

FIG. 3 is a schematic diagram of a foil antenna according to U.S. Pat. No. 4,987,424.

FIG. 4 is an exploded perspective drawing of elements which are used to make an RF-EAS tag of U.S. Pat. No. 6,177,871.

FIG. 5 is an elevation view in cross-section of a hot stamping foil according to a first embodiment prior to the transfer process.

FIG. 6 is an elevation view in cross-section of the foil of FIG. 5 following the transfer of the layers to the substrate.

FIG. 7 is an elevation view in cross-section of a hot stamping foil according to a second embodiment.

FIG. 8 is a schematic drawing of a catatonic adhesive application method.

FIG. 9 is a schematic drawing of a free-radical adhesive application method.

FIG. 10 is a schematic drawing of a rotary hot stamping application method.

FIG. 11 is a schematic drawing of a vertical hot stamping method.

### DESCRIPTION OF THE PREFERRED EMBODIMENTS

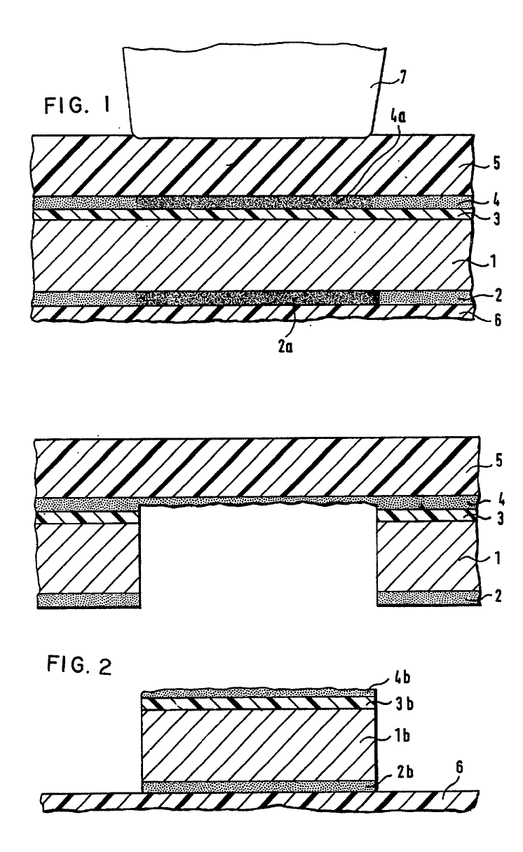

Referring to FIG. 1 in conjunction with FIG. 2 a stamping foil, which U.S. Pat. No. 4,495,232 teaches, resembles those used heretofore except for the relative dimensions. The stamping foil includes several layers: (a) a functional layer (e.g., around 50 millimicrons thick in the hot-stamping foils used heretofore) which has generally a decorative or graphic function, however, being of thin metal, it can also be somewhat conductive electrically but not conductive enough for printed circuit applications; (b) one or more strata of a melting glue 2 (e.g., 3 microns thick); (c) a protective layer 3 (e.g., 1.5 microns thick); (d) a separating layer 4 (e.g., around 100 millimicrons thick); and (e) a carrier tape 5 (e.g., of polyester about 12 microns thick). In contradistinction from the heretofore used dimensions, the functional layer layer of FIG. 1 is extraordinarily thick as compared with the carrier tape 5. The thickness ratio for these two layers is quite appropriate for the hot-stamping foil. In order to form a printed pattern the hot-stamping foil is laid down as a tape on a substrate 6 and is pressed against the substrate by means of a stereotype 7 affixed to a heated stamping die. In the areas of the foil subjected to the heat and compression by the stereotype 7, a component 2a of the melting glue 2 becomes activated and causes the functional layer 1 to be bonded to the substrate in accordance with the stereotype pattern, while a component 4a of the separating layer 4 is activated so as to permit separation of the functional layer 1 with his protective layer 3 from the carrier type 5. After lifting the stereotype 7 and carrier tape 5 together with the residual unactivated part of the hot-stamping foil from the support 6, the previously compressed area 1b of the functional layer 1 together with portion 3b of the protective layer 3 and any residue 4b from the separating layer 4 remain firmly attached by the solidified component 2b of the melting glue to the substrate 6. There is no pattern punched out of the carrier foil as would happen with the punching or blanking process (often also called stamping). If the functional layer 1 of such a hot-stamping foil consisted of the usual copper foil, e.g., 10 microns thick, as would be necessary and sufficient for many printed circuit applications, then no conductive patterns could be produced by this method, because it would not be possible to obtain a sharp separation of the conductive paths in accordance with the stereotype pattern, as the copper foil would adhere irregularly and partly to the substrate and partly to the carrier tape or else entirely to either one of these. The functional layer 1 of the stamping foil consists of a material whose structure and composition endow it with a shear strength so low as to permit stamping of conductive paths or even integrated electrical components of a thickness similar to that in conventional printed circuit plates (e.g., 10 to 35 microns) and thereafter obtain a sharp separation of the residual (not compressed) parts of the conductive layer upon pulling away the carrier tape. For instance, the functional layer 1 may consist of a copper foil having a shear strength of between 10 to 50 N/mm2 with sufficient ductility for the production of the foil in the form of a roll.

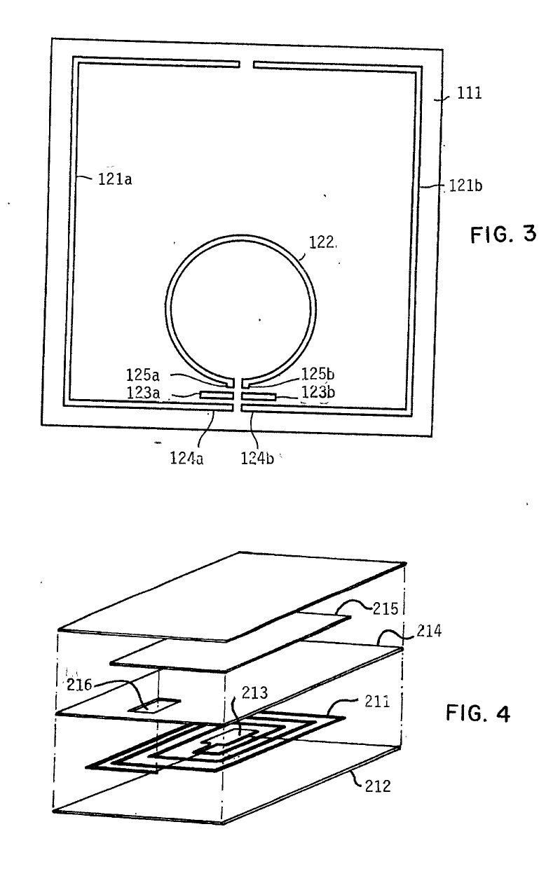

Referring to FIG. 3 an antenna apparatus 110, which U.S. Pat. No. 4,987,424 teaches, includes an electrically insulating sheet 111 which is a 0.125 millimeter thick film and is formed of a synthetic resin material such as polyester, polyamide or vinyl chloride. Paper, a sheet obtained by stacking paper and a synthetic film, or the like may also be used, depending upon applications. The film 111 is thin and flexible and is formed of a transparent material. A pair of antennas 112a and 112b for receiving, e.g., FM programs, is formed on the surface of film 111. The antennas 112a and 112b include band-like extension coils 113a and 113b which are bent to have a wave shape. Each antenna 112a and 112b is obtained by cutting out a predetermined shape from a foil formed of a conductive material such as aluminum or copper and is adhered to the surface of the film 111 with an adhesive. The shape of an antenna element corresponds to a frequency band to be received. The antennas 121a and 121b for receiving a VHF band, antenna 122 for receiving a UHF band, and auxiliary terminals 123a and 123b are formed. The antennas 121a and 121b are bent along an edge portion of substantially square film 11, thereby making the entire antenna apparatus compact. End portions of the antennas 121a and 121b are formed to be feeder portions 124a and 124b, and end portions of antenna 22 are formed to be feeder portions 125a and 125b, respectively. Terminal portions 123a and 123b are used when reception signals from the two antennas (121a, 121b) and 122 are to be mixed with each other by a pair of feeders (not shown) and extracted.

Referring to FIG. 4 an RF-EAS tag 210, which U.S. Pat. No. 6,177,871 teaches, is applied directly to the paper, paper-board or plastic substrate by a process. The process involves first applying an inductor element 211 onto the surface of the substrate 212 and then printing a capacitor element 215 over the inductor. The inductor 211 is a metal foil. The metal foil is either die-stamped or hot-stamped on the upper face of the substrate 212. There are other methods which capable of being applied at high speed in a continuous manner could be used such as laminating and etching or printing. Inductor element 211 includes a lower capacitor plate 213. Next, a low-loss polymer coating 214 prepared from polystyrene, polyethylene or the like is applied over the inductor 211 as an emulsion dispersed in a suitable binder. The polymer coating 214 is applied by printing or coating using conventional equipment. Subsequently, a top capacitor plate 215 is applied over the polymer coating preferably by printing with a conductive ink. Means is provided in the form of an opening 216 in polymer coating 214 to permit contact between the lower capacitor plate 213 of inductor 211 and top capacitor plate 215 to form a resonant circuit.

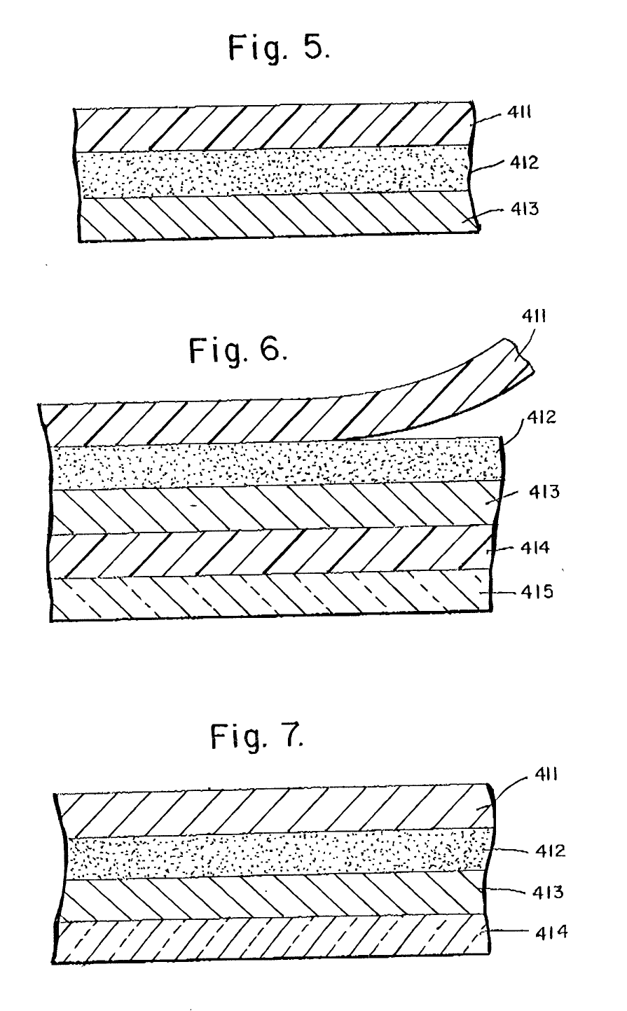

Referring to FIG. 5 in conjunction with FIG. 6 a hot stamping foil 410 includes a carrier film layer 411, a layer 412 of heat activated release and a layer of metal 413, such as copper, gold, silver and platinum, in the range of 50 to 1,000 angstroms thick layer of heat activated adhesive coating. The hot stamping foil 411 also includes a release layer 414 of a cold adhesive and a substrate 415 on which is formed a circuit. The hot stamping foil 410 is similar to those used previously, but has differing relative layer dimensions and metal composition. The metal layer 413 (in normal stamping foil is approximately 150 angstroms) is used for decorative purposes such as greeting cards, labels, cosmetic packaging and similar and is normally constructed with either vacuum deposited aluminum or sputtering. In the prior art aluminum has been used, but aluminum, which is electrically conductive, is not useful because it has an inherent resistance which is not suitable for many conductive circuit processes or applications.

Either a radio frequency antenna or a printed circuit is formed by using a hot stamping foil forming the circuit patterns, comprising an electrically conductive layer made of a highly conductive metal, for example vacuum deposited copper or tin, having a thickness of 50 to 1000 Angstroms (1000 microns equals 10 microns), deposited on a plastic film carrier and allowing a clean fast and efficient separation of the metal to a substrate when imprinted. This can be achieved by applying heat and pressure to the non coated side of the plastic film. A release coating is applied to the carrier film, metallized and transferred to the article by means of hot stamping or utilizing cold transfer adhesive. The layers become activated when compressed by a hot stamping die or a silicone rubber roller, whereby the metal becomes bonded to the substrate and the non-imprinted areas are separated by removing the carrier film away from the substrate.

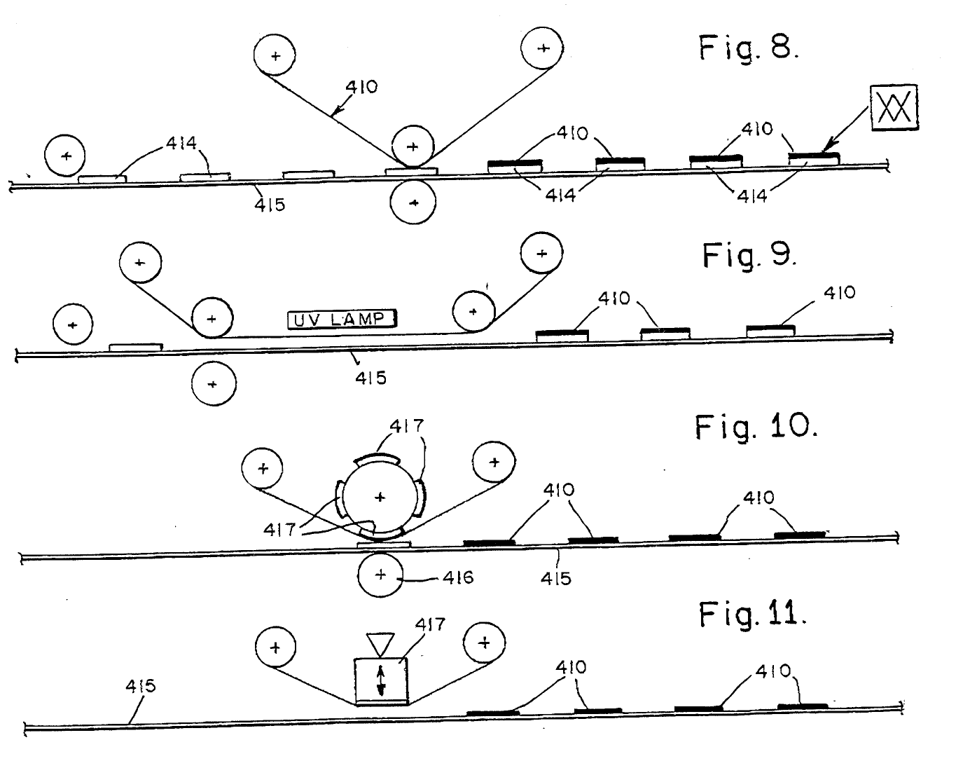

Referring to FIG. 7 in conjunction with FIG. 8, FIG. 9, FIG. 10 and FIG. 11 a printed pattern or electrically conductive circuit is accomplished by printing a cold foil adhesive 414 onto the surface of the substrate 415 forming the circuit, the layers 412 and 413 on the carrier film 411 are transferred by means of a nip roller 416 either cold or with heat and pressure. The areas where the imprinted pattern is adhered form the printed circuit, the residue remains on the carrier film and is discarded.

Forming a printed pattern or electrically conductive circuit using the process in FIG. 11 is accomplished by the application of heat and pressure through the stamping die 417, the layers are pressed onto the surface of the substrate 415 forming the printed circuit pattern. The areas where the imprinted pattern has not been transferred will remain on the surface of the carrier film and discarded.

The metal layer 413 consists of, but is not limited to, copper or tin having a thickness in the range of 50 to 1000 angstroms thick. This is adequate for may radio frequency antennas and other types of printed circuits. The material has a structure and a composition which allows a low level of shear strength and which permits the transfer of a conductive pattern using mass production techniques, suitable for many circuit applications presently constructed by conventionally printed or etched techniques which are slower and not as productive.

An additional feature is that the metal layer when transferred to the substrate 415 allows the use of cold attachment techniques to attach electronic chips or other transducers at high speeds accomplishing in-line production of such devices by conductive adhesives. Another feature is that the metal layer is not limited to copper or tin as other metals, such as silver, gold, platinum, or metal oxides may be used in combination with various transducers such as semiconductors, photo-conductors and similar devices to produce electronic components.

There will be obvious modifications to those skilled in the art or variations of the embodiments, which will remain within the scope of this invention.

From the foregoing it can be seen that stamping foils and methods for making printed circuits and radio frequency antennas have been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

What is claimed is:

1. A stamping foil comprising:
a. a carrier film;
b. a layer of heat activated adhesive;
c. a layer of vacuum deposited copper wherein said layers are activated by heat and pressure by a die which causes said layers to delaminate from said carrier film and adhere to a surface of a substrate in a predetermined electrically conductive pattern;
d. a substrate; and
e. a release layer which releasably couples said layer of vacuum deposited copper to said substrate.

2. A stamping foil for use in making printed circuits on a non-conductive substrate wherein said stamping foil may be bonded to said non-conductive substrate in areas and is activated by compression with a stamping die and wherein said stamping foils comprises an electrically conductive layer which has a thickness of between 50 Angstroms to 1000 Angstroms to achieve the required electrical functions wherein said foil is endowed with sufficiently low shear strength to permit sharp separation of said activated areas from unactivated areas of the foil following a stamping operation.
